(19) United States
(12) Patent Application Publication
(10) Pub. No.: US 2008/0189949 A1
(43) Pub. Date: Aug. 14, 2008

(54) REINFORCING BEAM STRUCTURE

(75) Inventor: Thomas Vikstrom, Troy, MI (US)

Correspondence Address: GIFFORD, KRASS, SPRINKLE,ANDERSON & CITKOWSKI, P.C, PO BOX 7021, TROY, MI, 48007-7021, US

(73) Assignee: Noble Advanced Technologies, Inc., Warren, MI (US)

(21) Appl. No.: 12/029,495

(22) Filed: Feb. 12, 2008

Related U.S. Application Data
(60) Provisional application No. 60/889,308, filed on Feb. 12, 2007.

(51) Int. Cl. B21D 53/88; B60R 27/00

(52) U.S. Cl. 29/897.2; 296/187.12

(57) ABSTRACT

A high strength reinforcing beam structure is provided. The beam structure includes an elongated member, with at least a portion of a length of the member having a cross section which defines a first, a second, a third, and a fourth curved segment. Each of the curved segments has a shape that can be defined by a hyperbolic cosine function. In addition to the high strength reinforcing beam structure, a process for making such a structure is provided. The process includes feeding an elongated member at least partially into a roll forming machine, the machine forming at least a first portion of a length of the elongated member such that the cross section has a first, a second, a third, and a fourth curved segment, each of the curved segments defined by a hyperbolic cosine function.

### CROSS REFERENCE TO RELATED APPLICATIONS

This application claims priority of U.S. Provisional Patent Application Ser. No. 60/889,308 filed Feb. 12, 2007, entitled “Reinforcing Beam Structure” which is incorporated herein by reference.

### FIELD OF THE INVENTION

This invention relates generally to structural elements. More specifically, the invention relates to reinforcing beams. In particular, the invention relates to reinforcing beams configured and operable to absorb impacts perpendicular to the length thereof.

### BACKGROUND OF THE INVENTION

Reinforcing beams are incorporated into a variety of structures, including motor vehicles, to increase the resistance of those structures to impacts. In particular, reinforcing beams, also referred to as side impact beams, are incorporated into door panels and body panels of motor vehicles so as to increase their strength in side impact collisions. Likewise, such reinforcing beams may be incorporated into bumpers, roof structures, and the like. Also, such beams may be utilized in applications other than motor vehicles such as static structures.

In general, it is desirable that any such reinforcing beams have a high strength to weight ratio, since weight represents loss in efficiency in mobile structures such as motor vehicles, and in any instance, represents material costs. In order to increase the strength, and hence the strength to weight ratio of such beams, various configurations of beam design have been implemented in the prior art. For example, U.S. Pat. No. 6,554,345 discloses a lightweight beam with two flanks that have a cross section that follows the equation y=cos hyp (x). However, the '345 patent results in a beam with an open back side that if closed, must have strips of sheet metal or a sheet steel cover spot welded to the two flanks. Joining the strips of sheet metal or the sheet steel cover to the two flanks, which provides improved rigidity to the beam, requires additional manufacturing steps to cut and/or form the beam and join the sheet material thereto.

As will be explained in detail hereinbelow, the present invention recognizes that beams having a particularly configured cross section will provide a structure having a very high strength to weight ratio. Furthermore, the configuration of the beams of the present invention may be readily fabricated by high speed, relatively simple processes such as roll forming. These and other advantages of the invention will be apparent from the drawings, discussion and description which follow.

### SUMMARY OF THE INVENTION

A high strength reinforcing beam structure is provided. The beam structure includes an elongated member, with at least a portion of a length of the member having a cross section which defines a first, a second, a third, and a fourth curved segment. Each of the curved segments has a shape that can be defined by a hyperbolic cosine function. In addition to the high strength reinforcing beam structure, a process for making such a structure is provided. The process includes feeding an elongated member at least partially into a roll forming machine, the machine forming at least a first portion of a length of the elongated member such that the cross section has a first, a second, a third, and a fourth curved segment, each of the curved segments defined by a hyperbolic cosine function. In some instances, the process produces a cross section that includes a discontinuity between at least two of the curved segments. In other instances, the curvature of each of the curved segments can be identical or in the alternative the curvatures of the segments can all be different. In yet other instances, the curvature of at least two of the segments can be identical. In addition, the cross section of the elongated member can have two planes of symmetry and/or the cross section can be a closed cross section, or in the alternative an open cross section.

### BRIEF DESCRIPTION OF THE DRAWINGS

FIG. 1 is a perspective view of an embodiment of the present invention;

FIG. 2 is a cross-sectional view of an embodiment of the present invention;

FIG. 3 is a cross-sectional view of another embodiment of the present invention;

FIG. 4 is a cross-sectional view of yet another embodiment of the present invention;

FIG. 5A is a cross-sectional view of a prior art structural beam;

FIG. 5B is a cross-sectional view of a prior art structural beam;

FIG. 5C is a cross-sectional view of a prior art structural beam;

FIG. 5D is a cross-sectional view of a prior art structural beam;

FIG. 5E is a cross-sectional view of a prior art structural beam;

FIG. 5F is a cross-sectional view of a structural beam according to an embodiment of the present invention;

FIG. 5G is a cross-sectional view of a structural beam according to an embodiment of the present invention; and

FIG. 6 is a flowchart illustrating a method for an embodiment of the present invention.

### DETAILED DESCRIPTION OF THE PREFERRED EMBODIMENTS

The present invention comprises a high strength reinforcing beam structure. The beams of the present invention are generally elongated members, typically formed from high-strength materials such as steel. The beams are configured so that at least a portion of the length thereof has a particular cross-sectional profile which includes a first, a second, a third and a fourth curved segment, wherein the curvature of each of the segments is defined by a hyperbolic cosine function.

Curves defined by hyperbolic cosine functions are also generally known as catenary curves, and a catenary curve is a mathematical shape defined by a chain or other such flexible body which is supported at each of its ends by supports spaced apart at a distance less than the length of the flexible body, so that the flexible body will hang therebetween. The force of gravity acting on the flexible body will cause it to assume a curved shape referred to as a catenary.

The curves defining the segments of the cross section of the reinforcing beam of the present invention are catenary-type curves, although it is to be understood that these curves need not define a full catenary, but may comprise only a portion of a catenary. In general, the curves of the present invention are defined by a hyperbolic cosine function, and a general formula therefor is:

$$y = k ( \frac{{e}^{- x} + {e}^{+ x}}{2} )$$

where k is a constant and e is the base of natural logarithms, namely 2.718 . . . .

It has been found that reinforcing beams which incorporate such curved segments exhibit very high strength to weight ratios. Therefore, the use of such beams in motor vehicles allows for the manufacture of a safe, high strength, collision-resistant vehicle without unduly increasing the weight thereof. The beams of the present invention may be implemented in a variety of configurations, and the principles of the invention will be illustrated with regard to some specific embodiments; although, it is to be understood that various other embodiments may likewise be implemented in accord with the teaching presented herein and within the scope of the present invention.

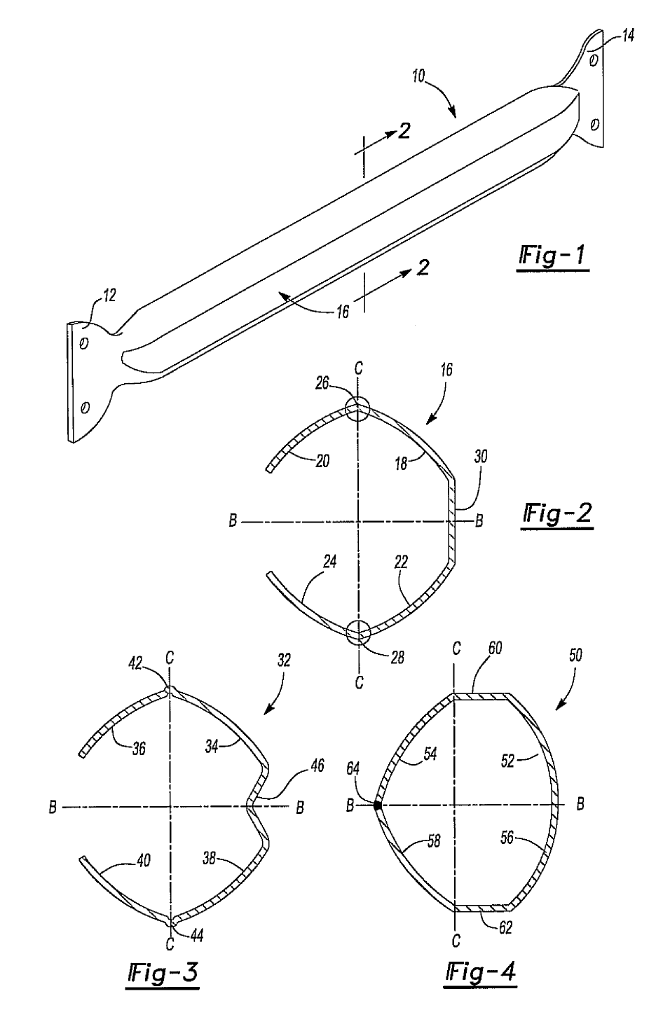

Referring now to FIG. 1, there is shown a perspective view of a typical reinforcing beam 10 of the type which may be implemented in accord with the present invention. The beam 10 of FIG. 1 is a generally elongated member, and as illustrated it includes mounting flanges 12, 14 at either end thereof. These flanges 12, 14 may be utilized to affix the beam 10 to a portion of a motor vehicle, such as a door frame or the like. The beam 10 includes a generally elongated length portion 16 extending between the flanges. As illustrated, the length portion 16 of FIG. 1 is of generally uniform cross section; although it is to be understood that in particular applications, the cross section of the length may vary. In accord with the present invention, at least a portion of the length 16 has a cross section which is configured to include at least four curved segments each defined by a hyperbolic cosine function.

Referring now to FIG. 2, there is shown a cross section of the length portion 16 of the beam 10 of FIG. 1 taken along line 2-2. As will be seen, the cross section of the length includes a first curved segment 18, a second curved segment 20, a third curved segment 22, and a fourth curved segment 24. Each of these curved segments 18-24 is defined by a hyperbolic cosine function. As shown in FIG. 2, the four segments 18-24 are all generally similar in their curvature; although it is to be understood that the curvatures may differ. In some instances, a beam may include four different curvatures for each segment, while in other instances two or more of the segments may have a similar curvature.

As further illustrated in FIG. 2, the cross section is symmetrical about a first axis B-B. Such axis symmetry is not required for the present invention, and beams having two-axis symmetry, or no symmetry, may likewise be implemented.

In the beam of FIG. 2, there are discontinuities between the four curved segments. For example, the first segment 18 and the second segment 20 meet so as to form a node 26, and the third segment 22 and fourth segment 24 likewise meet so as to form a node 28. The beam of FIG. 2 has an open profile, and hence the discontinuity between the second segment 20 and the fourth segment 24 comprises an opening.

In the illustration of FIG. 2, there is a discontinuity between the first segment 18 and the third segment 22, and this discontinuity comprises a generally planar portion 30 of the beam. It is to be understood that other discontinuities including curved surfaces, beads, creases, and irregular structures such as corrugated structures may define a discontinuity. It is further to be understood that the cross-sectional profile may include yet further segments, and these segments may be straight segments, irregular segments, or curved segments, and such curved segments may be curved to define a hyperbolic cosine function, or they may be otherwise curved.

Yet other embodiments of cross-sectional profiles may be utilized to fabricate the reinforcing beams. For example, FIG. 3 shows a cross section of another profile of beam 32. The beam of FIG. 3 includes a first curved segment 34, a second 36, a third 38, and a fourth 40 all of which are defined by a hyperbolic cosine function as discussed above. In the FIG. 3 embodiment, the first and second curved segments 34, 36 are separated by a discontinuity which comprises a bead 42. Likewise, the third segment 38 and the fourth segment 40 are separated by a similar bead 44. In this embodiment, the front face of the beam, between the first segment 34 and the third segment 38, comprises a discontinuity defined by a groove 46. As in FIG. 2, the FIG. 3 embodiment has an open profile and hence the discontinuity between the second segment 36 and the fourth segment 40 comprises an opening. It is to be understood that the presence of a discontinuity is not required between each segment. For example, in the FIG. 3 embodiment, the second segment 36 and the fourth segment 40 may join together so as to form a continuous catenary curve defined by the same hyperbolic cosine function, and the fact that both segments lie along a continuous curve does not preclude them from being considered, for the purposes of this disclosure, separate segments.

Referring now to FIG. 4, there is shown yet another cross-sectional view of a cross section of another beam 50. As will be seen, this beam has a profile which is asymmetric about its axis B-B. In FIG. 4, a first curved segment 52 is separated from a second curved segment 54 by a discontinuity 60 comprising a relatively flat top portion. Likewise, a third segment 56 is separated from a fourth segment 58 by a second relatively flat portion 62. The beam of FIG. 4 has a closed profile, and hence the second segment 54 and fourth segment 58 are joined together by a weld 64 which defines a discontinuity. In the FIG. 4 embodiment, the curvature of the first segment 52 and the curvature of the third segment 56 uniformly blend together and no discontinuity is found therebetween.

As discussed above, a single beam may be fabricated to have different cross-sectional profiles along its length, provided that at least a portion of the length of the beam has a profile comprised of four curved segments as discussed above. The remainder of the beam may have the very same profile, or it may be otherwise profiled. In some instances the beam may have two length segments each having a different cross-sectional profile, each of the profiles including four curved segments each defined by a hyperbolic cosine function, while in other instances a portion of the beam may be otherwise configured. For example, such other portions of the beam may include less than four curved segments defined by hyperbolic cosine functions.

The beams of the present invention may be fabricated from a variety of materials; although, for reasons of strength and weight, metals are one specifically preferred group of materials for their fabrication. Steel comprises one specific material which may be utilized for the fabrication of the beams, and such steels may comprise hardened or hardenable steels. In other instances, other metals such as aluminum and various alloys may likewise be employed, as may be composite materials such as reinforced polymers, carbon-carbon composites, metal matrix composites and the like.

A variety of processes may be utilized to fabricate the beams of the present invention. Roll forming is one process having particular utility in the fabrication of these beams, since roll forming may be readily implemented to form complex profiles in a high-speed process. Other forming techniques including stamping, pressing, bending and the like may be likewise employed as may be multi-step processes.

It has been found that beams fabricated in accord with the foregoing provide very good strength when subjected to loading in a direction perpendicular, or in an angled relationship, to their length and hence may be advantageously employed to increase the side impact resistance of motor vehicles. Likewise, the beams may be utilized as bumper bars or as reinforcements for roofs and other portions of a vehicular body. Beams fabricated in accord with the foregoing may also be incorporated into aircraft and watercraft as well as static building structures.

As an example, and for illustrative purposes only, testing of side impact door beams for motor vehicles made in accordance with an embodiment disclosed herein was compared with testing of prior art side impact door beams. The results the testing are shown in Table 1 below wherein the thickness of the sheet material used to make a given beam, the overall mass of the beam tested and the energy required to deform a door beam with a particular cross-sectional profile a distance of 6 inches was recorded. The cross-sectional profile for each beam is shown in FIG. 5.

TABLE 1

| | Thickness | | Specific Energy to |
|---|---|---|---|
| | of Sheet Material | | Deform Beam 6″ |
| Door Beam | (mm) | Mass (Kg) | (J/Kg) |
| 5A* | 2.200 | 1.676 | 1433 |
| 5B* | 1.855 | 1.467 | 1262 |
| 5C* | 1.912 | 1.465 | 1302 |
| 5D* | 2.045 | 1.465 | 1224 |
| 5E* | 2.039 | 1.465 | 1283 |
| 5F | 2.200 | 1.443 | 1495 |
| 5G | 2.550 | 1.673 | 1530 |

*Prior Art Beam Structures

As shown in the table above, door beams 5A-5E were beams having a prior art structure while door beams 5F and 5G had a structure in accord with the present invention, i.e. the cross section of beams 5F and 5G were defined by a first, a second, a third, and a fourth curved segment with each of the curved segments having a shape defined by a hyperbolic cosine function.

Regarding the prior art beam structures, door beam 5A was made from sheet steel having a thickness of 2.200 millimeters (mm) with an overall weight of 1.676 kilograms (Kg). Door beam 5A was also the strongest of the prior art beam structures requiring a specific energy of 1433 joules per kilogram (J/Kg) to deform 6 inches. In comparison, door beam 5F had a cross section in accord with the embodiment shown in FIG. 3, and was made from sheet steel having a thickness of 2.200 mm with an overall weight of 1.443 Kg. Although beam 5F weighed approximately 16% less than beam 5A, the specific energy to deform beam 5F 6 inches was 1495 J/Kg—approximately 4% greater than for beam 5A.

Referring now to the data shown for beam 5G, which also had a cross section in accord with the embodiment shown in FIG. 3, this beam was made from sheet steel having a thickness of 2.550 mm, yet had an overall weight less than beam 5A. However, beam 5G required a specific energy of 1530 J/Kg to deform the beam 6 inches—approximately 7% greater than for beam 5A. As such, beams having a cross section as taught herein and having a weight approximately equal to or less than prior art beams, provide increased resistance to deformation. These results are unexpected given that the reinforcing beams disclosed herein weigh less than prior art reinforcing beams.

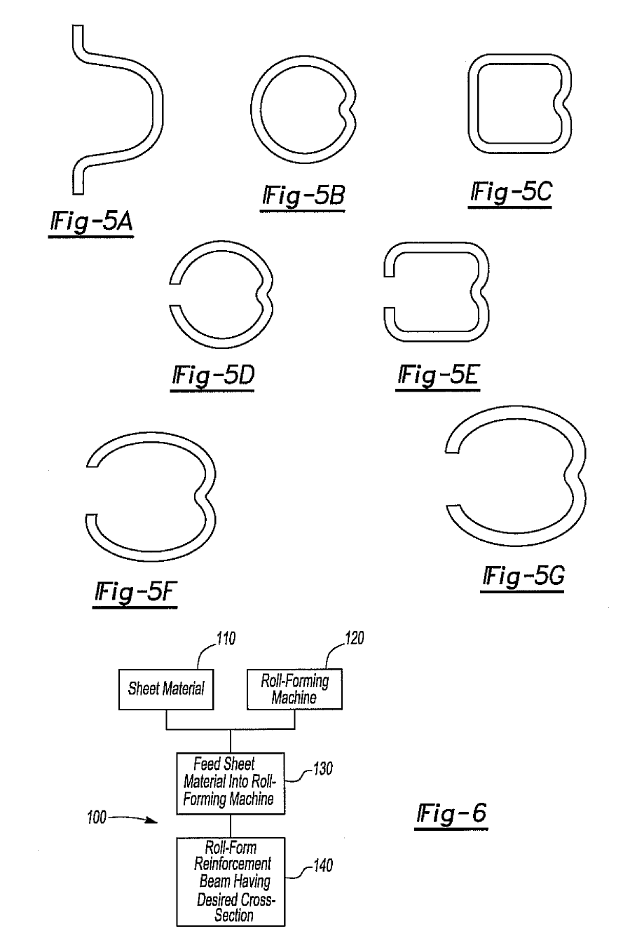

Also disclosed herein is a method or process for making reinforcing beams having cross sections as taught above. Turning now to FIG. 6, a flowchart illustrating an embodiment of a method to form the reinforcing beam structures is shown generally at reference numeral 100. The method 100 includes providing a sheet material at step 110 and providing a roll forming machine at step 120. It is appreciated that the roll-forming machine can be a hot roll forming machine or a cold roll-forming machine. By hot forming, it is meant within the scope of the present invention to form a material above its recrystallization temperature. Likewise, cold forming is understood to mean the forming or deformation of the sheet material below its recrystallization temperature. At step 130, the sheet material is fed into the roll forming machine and the sheet material is roll formed to produce a reinforcement beam having a desired cross section as taught above. Although roll forming is shown in FIG. 6, it is appreciated that other deformation processes known to those skilled in the art can be used to produce the reinforcement beam taught herein, illustratively including extrusion processing, multi-step stamping and the like. In this manner, a reinforcing beam structure is provided that has unexpected high strength given the reduced weight that is available compared to prior art beam structures.

The foregoing has described some specific embodiments of the beams of the present invention but is not meant to be a limitation upon the practice thereof. Numerous modifications and variations of the foregoing will be readily apparent to those of skill in the art. It is the following claims, including all equivalents, which define the scope of the invention.

1. A process for making a reinforcing beam, the process comprising:
providing an elongated member;
providing a roll-forming machine;
feeding the elongated member at least partially into the roll-forming machine; and
rolling at least a first portion of a length of the elongated member so that a cross section of the elongated member has a first, a second, a third, and a fourth curved segment, each of the curved segments being defined by a hyperbolic cosine function.

2. The process of claim 1, wherein the cross section includes a discontinuity between at least two of the curved segments.

3. The process of claim 1, wherein the curvature of each of the curved segments is identical.

4. The process of claim 1, wherein the curvatures of the segments are all different.

5. The process of claim 1, wherein the curvatures of at least two of the segments are identical.

6. The process of claim 1, wherein the cross section has two planes of symmetry.

7. The process of claim 1, wherein the cross section is a closed cross section.

8. The process claim 1, wherein the cross section is an open cross section.

9. The process of claim 1, further including a second portion of the length of the elongated member which has a cross section different from the cross section of the first portion, the cross section of the second portion defining at least one curved segment defined by a hyperbolic cosine function.

10. The process of claim 1, wherein the beam is an intrusion beam for a motor vehicle.

11. A reinforcing beam made according to the process of claim 1.

12. The reinforcing beam of claim 12, wherein said reinforcing beam is fabricated from steel.

13. A process for making a reinforcing beam, the process comprising:
providing an elongated member of steel sheet;
providing a roll-forming machine having a plurality of rollers for roll forming steel sheet;
feeding the elongated member at least partially into a roll-forming machine; and
rolling at least a first portion of a length of the elongated member so that a cross section of the elongated member has a first, a second, a third, and a fourth curved segment, each of the curved segments being defined by a hyperbolic cosine function.

14. The process of claim 13, wherein the roll forming is cold roll forming.

15. The process of claim 14, wherein the cross section includes a discontinuity between at least two of the curved segments.

16. The process of claim 14, wherein the curvature of each of the curved segments is identical.

17. The process of claim 14, wherein the curvatures of the segments are all different.

18. The process of claim 14, wherein the curvatures of at least two of the segments are identical.

19. A reinforcing beam made according to the process of claim 14.

20. A reinforcing beam comprising:
an elongated member, at least a portion of a length of said member having a cross section which defines a first, a second, a third, and a fourth curved segment, each of said curved segments being defined by a hyperbolic cosine function.
